(19) United States
(12) Patent Application Publication
(10) Pub. No.: US 2007/0298933 A1
(43) Pub. Date: Dec. 27, 2007

(54) SELF CLEANING LOGIC VALVE ASSEMBLY

(76) Inventors: CHARLES F. LONG, Pittsboro, IN (US); Phillip F. Mc Cauley, Zionsville, IN (US); Scott E. Mundy, Carmel, IN (US)

Correspondence Address: GENERAL MOTORS CORPORATION;LEGAL STAFF, MAIL CODE 482-C23-B21, P O BOX 300, DETROIT, MI, 48265-3000, US

(21) Appl. No.: 11/426,625

(22) Filed: Jun. 27, 2006

(51) Int. Cl. F16H 61/06

(52) U.S. Cl. 477/149

(57) ABSTRACT

The present invention provides a method and apparatus for a self cleaning logic valve assembly. The logic valve assembly is adapted to cycle and thereby clean itself in response to one or more predefined parameters which are programmed into a programmable controller. The logic valve assembly is additionally configured to cycle according to one or more of several different methods which have been shown to efficiently clean the valve assembly. The cleaning process takes place during a predetermined time period selected to avoid causing an unwanted gear speed ratio change of the vehicle transmission. In this manner, the logic valve assembly may be automatically cleaned while the vehicle is being driven and without interfering with vehicle operation such that the valve cleaning is imperceptible to the operator.

### TECHNICAL FIELD

This invention relates to a self cleaning logic valve assembly for a vehicle transmission.

### BACKGROUND OF THE INVENTION

Since debris can build up in a valve assembly over time and thereby increase valve friction, it is desirable to provide a self cleaning valve assembly. Logic valves such as those used in the hydraulic control systems of automatic transmissions are particularly prone to debris accumulation because they may remain in a given position for prolonged periods of time.

The industry standard for valve bore clearances on transmission control systems is 0.0008″ to 0.0023″ diametrical clearance. This allows for 0.0005″ total tolerance on the valve diameter and 0.001″ total tolerance on the valve bore. These tolerances are well established and it is difficult to reduce the tolerance further without much more expensive part processing. It has been observed that if the filtration system does not filter out debris greater than 0.0008″, there is the potential for debris to cause valve sticking. Typically automotive filters trap debris at sizes above 0.0024″. While higher filtration levels can provide better protection, such filters plug too quickly to be practical.

Valves are particularly sensitive to debris that is about the same size as the valve clearance. Single particles can be wedged between valve and valve body, solidly sticking the valve. Another situation can occur where particles smaller than the diametral clearance can accumulate between the valve and the valve body and gradually increase friction to the point that valve stroke times are delayed or the valve momentarily sticks. Large buildups can cause friction to overcome the return spring force causing the valve to stick in a stroked position.

### SUMMARY OF THE INVENTION

The present invention provides a method and apparatus for a self cleaning logic valve assembly. The logic valve assembly is adapted to cycle and thereby clean itself in response to one or more predefined parameters which may be programmed into a programmable controller. The logic valve assembly is additionally configured to cycle according to one or more of several different methods which have been shown to efficiently clean the valve assembly. The cleaning process takes place during a predetermined time period selected to avoid causing an unwanted gear speed ratio change of the vehicle transmission. In this manner, the logic valve assembly may be automatically cleaned while the vehicle is being driven and without interfering with vehicle operation such that the valve cleaning is imperceptible to the operator.

The logic valve assembly may be completely de-stroked and stroked multiple times to clear any debris. Alternatively, the logic valve assembly may be shaken by a high frequency dither, partially de-stroked several times, partially stroked several times, etc.

The frequency and duration of logic valve assembly cleaning may be based on a vehicle mileage parameter. Alternatively, the frequency and duration of logic valve assembly cleaning may be based any number of other parameters such as time in range, shift density, the time required to stroke the valve, etc.

It has been observed that cycling the logic valve assembly in the manner described herein efficiently clears valve debris, however, it should be appreciated that any method wherein the logic valve assembly is cycled may be implemented for this purpose.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 shows a schematic illustration of an exemplary hydraulic control system;

FIG. 2 shows a schematic cross-sectional view of a self cleaning valve assembly having a valve disposed within a bore of a valve body according to the present invention;

FIG. 2a shows a schematic cross-sectional view of a single large particle disposed between the valve and valve body of FIG. 1;

FIG. 2b shows a schematic cross-sectional view of a plurality of smaller particles disposed between the valve and valve body of FIG. 1;

FIG. 3 is a graph depicting a method of the present invention wherein the valve is completely de-stroked and stroked multiple times;

FIG. 4 is a graph depicting a method of the present invention wherein the self cleaning valve assembly of FIG. 1 is shaken by a high frequency dither;

FIG. 5 is a graph depicting a method of the present invention wherein the valve is partially de-stroked several times;

FIG. 6 is a graph depicting a method of the present invention wherein the valve is partially stroked several times;

FIG. 7 is a graph depicting a method of the present invention wherein the cleaning frequency of the self cleaning valve assembly of FIG. 1 is based on a vehicle mileage parameter;

FIG. 8 is a graph depicting a method of the present invention wherein the cleaning frequency of the self cleaning valve assembly of FIG. 1 is based on a time in range parameter;

FIG. 9 is a graph depicting a method of the present invention wherein the cleaning frequency of the self cleaning valve assembly of FIG. 1 is based on a shift density parameter; and

FIG. 10 is a graph depicting a method of the present invention wherein the cleaning frequency of the self cleaning valve assembly of FIG. 1 is based on a parameter reflecting the time required to stroke the valve.

### DESCRIPTION OF THE PREFERRED EMBODIMENTS

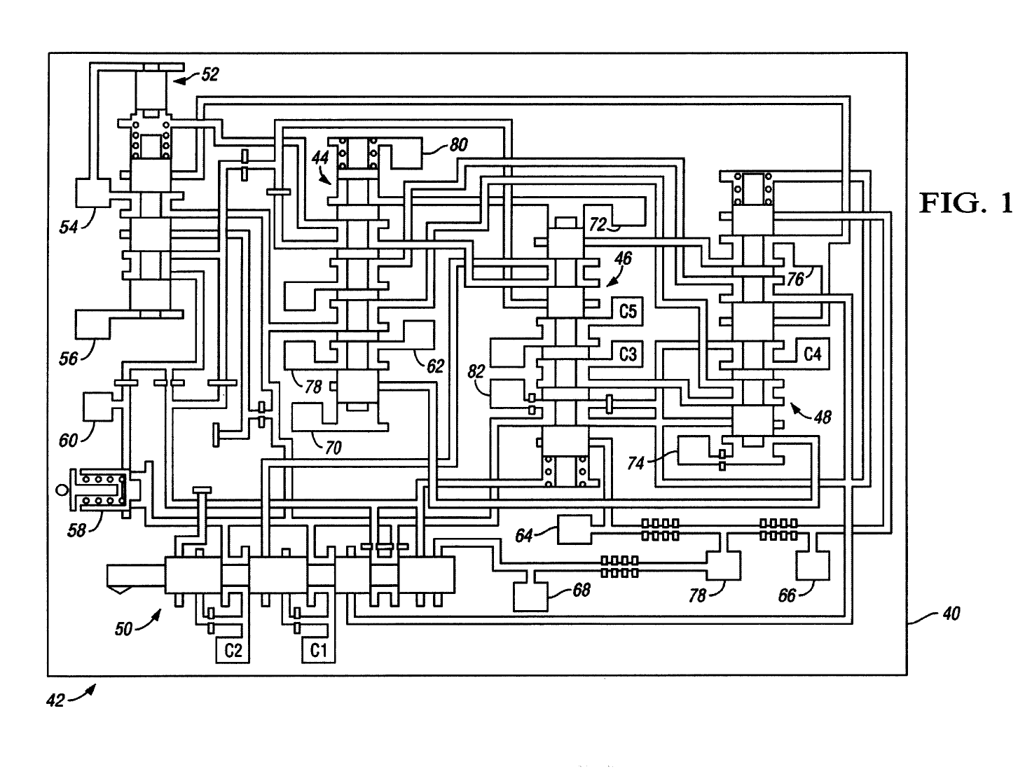

Referring to the drawings wherein like reference numbers refer to like components, FIG. 1 shows a schematic illustration of a hydraulic control system 40 for a vehicle transmission 42. It should be appreciated that the hydraulic control system 40 is shown for exemplary purposes, and that the present invention is applicable to alternate hydraulic control system configurations.

The hydraulic control system 40 includes a plurality of logic valves 44, 46 and 48. The logic valves 44, 46 and 48 are configured to control the transfer of hydraulic fluid (not shown) to one or more of a plurality of clutches C1, C2, C3, C4 and C5. By controlling the transfer of hydraulic fluid to the clutches C1, C2, C3, C4 and C5, the status of the clutches (i.e., either “engaged” or “released”) is similarly controllable. It should be appreciated by those skilled in the art that by controlling the status of the clutches C1, C2, C3, C4 and C5, the gear speed ratio of the vehicle transmission 42 is also controlled. As an example, when the vehicle transmission 42 is in second gear, clutches C1 and C4 are engaged; and when the vehicle transmission 42 is in third gear, clutches C1 and C3 are engaged. Therefore, a gear speed ratio change from second gear to third gear can be effected by blocking the transfer of hydraulic fluid to clutch C4 and transferring hydraulic fluid to clutch C3.

In some circumstances, the logic valves 44, 46 and 48 can be actuated or cycled without changing the status of the clutches C1, C2, C3, C4 and C5. Referring to the exemplary hydraulic control system 40, when the vehicle transmission 42 is in second gear the logic valve 46 is actuatable without changing the status of the clutches C1, C2, C3, C4 and C5. In other words, when the vehicle transmission 42 is in second gear, the clutches C2, C3, and C5 remain “released” regardless of valve 46 position; and the clutches C1 and C4 remain “engaged” regardless of valve 46 position. Therefore, a vehicle incorporating the hydraulic control system 40 which is being driven in second gear can actuate and thereby clean the logic valve 46 while the vehicle is moving and without interfering with vehicle operation such that the valve cleaning is imperceptible to the operator.

When the vehicle transmission 42 is in third gear, the logic valve 44 is actuatable without changing the status of the clutches C1, C2, C3, C4 and C5; and when the vehicle transmission 42 is in fourth gear, the logic valve 48 is actuatable without changing the status of the clutches C1, C2, C3, C4 and C5. While the present invention has been described as applied to the exemplary hydraulic control system 40, alternate hydraulic control system configuration generally include at least one speed ratio wherein each of the control system logic valves can be actuated without changing the status of the transmission clutches. Accordingly, the logic valves 44, 46 and 48 can all be cycled and thereby cleaned at a predetermined time while the vehicle is being driven and without interfering with vehicle operation.

The hydraulic control system 40 also includes a manual selector valve 50 which is manually positioned by the operator to select a gear speed range (i.e., park, reverse, neutral, drive, etc.); and a torque converter valve 52 configured to control the actuation of a torque converter 54. Torque converter valve 52 actuation is preferably performed with a torque converter solenoid 56. A conventional accumulator 58 and exhaust valve 60 are preferably provided to store and release energy in a controllable manner.

The logic valves 44, 46, 48, and the manual selector valve 50, respectively include a pressure switch 62, 64, 66, and 68 configured to measure valve position. The logic valves 44, 46 and 48 are each actuated by a shift solenoid 70, 72 and 74, respectively. The hydraulic control system 40 includes a high pressure hydraulic fluid source 76, and steps down this high pressure level via a plurality of regulator valves 78 configured to maintain a predetermined pressure level. An exhaust passage 80 relieves excess pressure in the spring pocket of the logic valve 44. An overdrive knockdown device 82 is configured to reduce the hydraulic fluid pressure level when the vehicle transmission 42 is operating in overdrive.

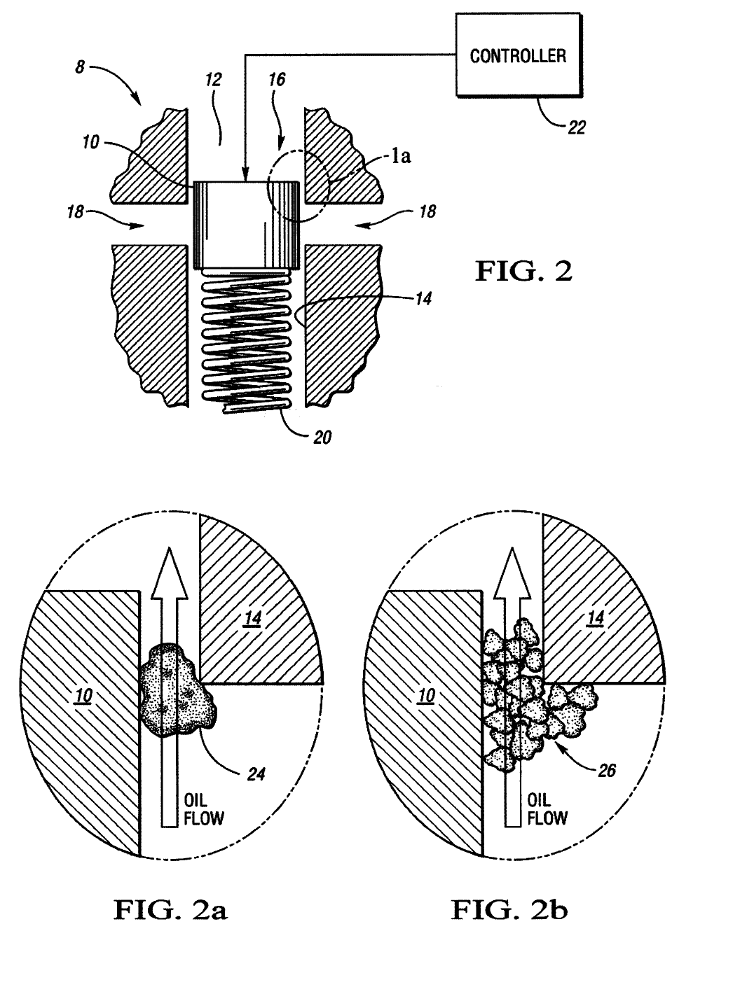

Referring to FIG. 2, a self cleaning logic valve assembly 8 which may represent any of the logic valves 44, 46 or 48 (shown in FIG. 1) is shown in more detail. The self cleaning logic valve assembly 8 has a valve 10 disposed within a bore 12 of a valve body 14. The valve body 14 further defines one or more pressure ports 16 and one or more outlet ports 18. A return spring 20 engages the valve 10 within the bore 12. As pressure is introduced into the pressure port 16 the valve 10 is displaced thereby compressing the return spring 20 to open the outlet ports 18. The logic valve assembly 8 is preferably electronically controlled by a programmable controller 22 adapted to regulate fluid flow into the pressure port 16 and thereby actuate the valve 10. The programmable controller 22 is further adapted to generate a triggering signal or profile that controls the frequency and duration of valve assembly cleaning.

As best seen in FIG. 2a, a single large particle 24 may become wedged between the valve 10 and the body 14. Alternatively, as shown in FIG. 2b, a plurality of smaller particles 26 may become trapped between the valve 10 and the body 14. A build-up of debris composed of particles 24 and/or 26 increases valve friction thereby reducing the efficiency of logic valve assembly 8. The self cleaning logic valve assembly 8 is therefore adapted to automatically clear such debris to maintain optimal valve performance as described in detail hereinafter.

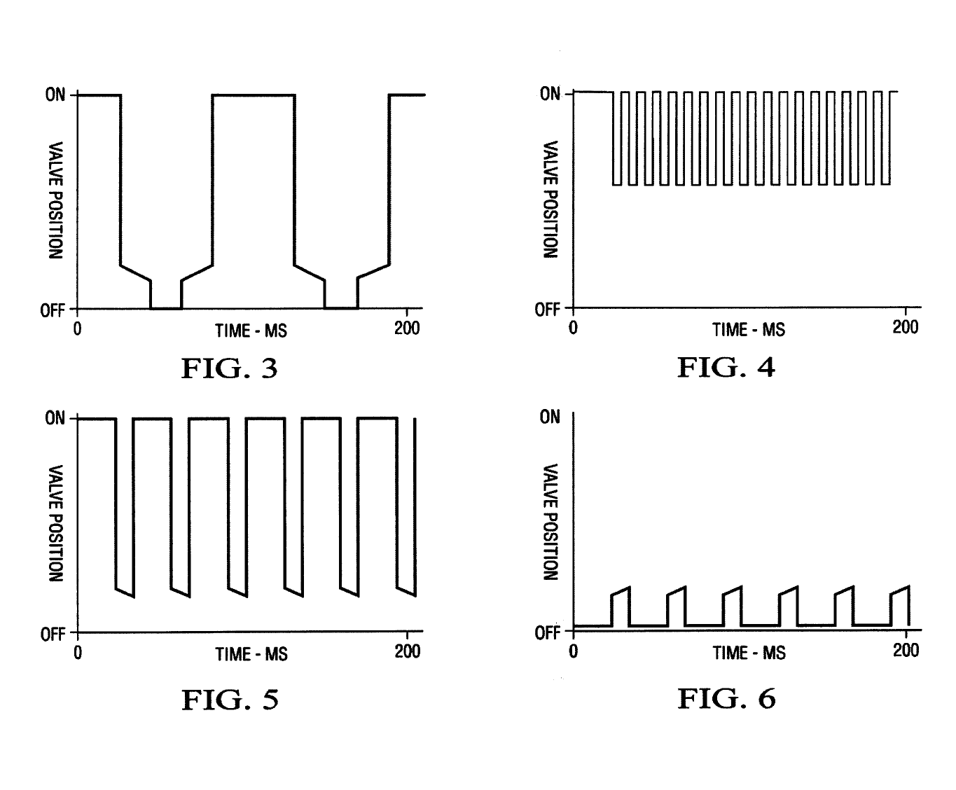

In a preferred embodiment, the self cleaning logic valve assembly 8 is implemented in a transmission system, however, it should be appreciated that the self cleaning valve may be used with any number of other systems as well. FIGS. 3-6 which are described in detail hereinafter show several preferred methods for cycling and thereby cleaning a valve assembly, however, it should be appreciated that any method wherein the valve is cycled may be implemented for this purpose.

FIG. 3 shows a method of the present invention wherein the valve 10 is completely de-stroked and stroked multiple times to clean the logic valve assembly 8. More precisely, FIG. 3 is a graph of valve position versus time as the valve 10 is completely de-stroked from the on position to the off position, and thereafter completely stroked from the off position to the on position. The speed and duration of the method of FIG. 3 are pre-defined according to the needs of a particular application and may be programmed into the programmable controller 22.

FIG. 4 shows a method of the present invention wherein the valve 10 is shaken by a high frequency dither that has a duration long enough to physically move the logic valve assembly 8 a slight amount. More precisely, FIG. 4 is a graph of valve position versus time as the valve 10 is rapidly cycled back and forth between the on position and an intermediate valve position. The frequency of the signal is preferably based on the natural frequency of the valve 10.

FIG. 5 shows a method of the present invention wherein the valve 10 is partially de-stroked several times. More precisely, FIG. 5 is a graph of valve position versus time as the valve 10 is cycled back and forth between the on position and an intermediate valve position. The speed and duration of the method of FIG. 5 are pre-defined according to the needs of a particular application and may be programmed into the programmable controller 22.

FIG. 6 shows a method of the present invention wherein the valve 10 is partially stroked several times. More precisely, FIG. 6 is a graph of valve position versus time as the valve 10 is cycled back and forth between the off position and an intermediate valve position. The speed and duration of the method of FIG. 6 are pre-defined according to the needs of a particular application and may be programmed into the programmable controller 22.

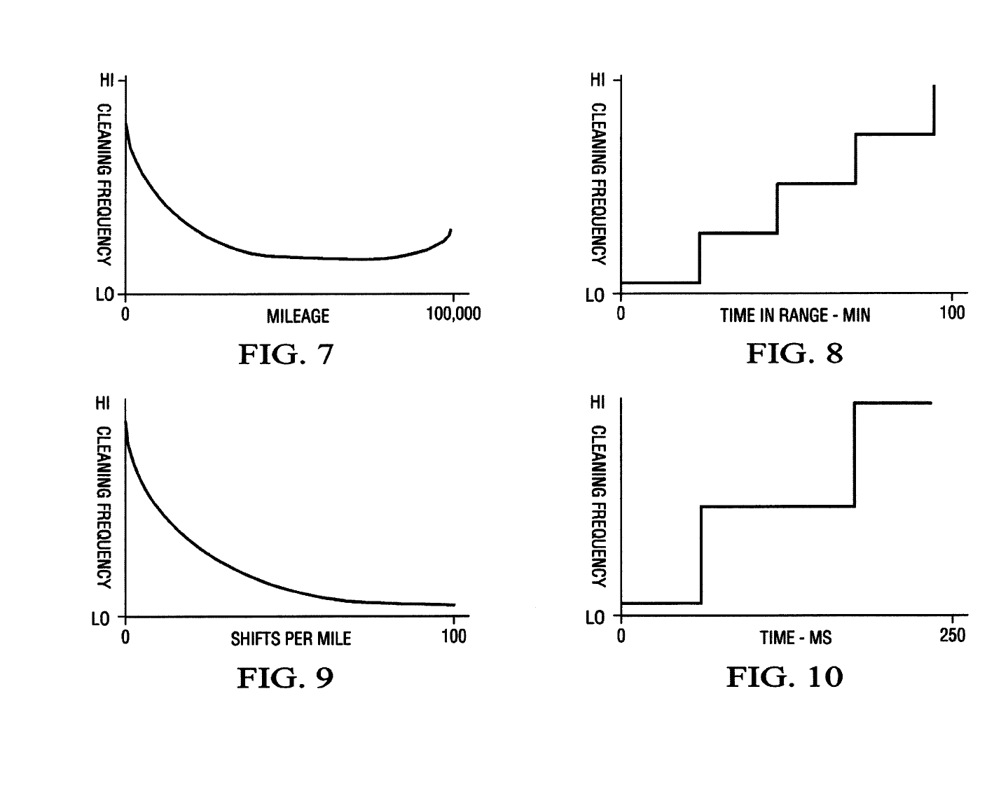

The frequency and duration of the valve cleaning described herein are preferably programmed into the programmable controller 22 as a function of one or more different parameters or triggers. As an example such parameters may include vehicle mileage, time in range, shift density, throttle, speed changes, oil temperature, oil age, etc. FIGS. 7-10 show several preferred parameters adapted to control frequency and duration of valve cleaning, however, it should be appreciated that any number of alternate parameters may be implemented for such a purpose.

FIG. 7 shows a cleaning frequency based on a vehicle mileage parameter. More precisely, FIG. 7 is a graph of cleaning frequency versus vehicle mileage wherein the logic valve assembly 8 is cleaned less frequently as vehicle mileage increases. The embodiment shown in FIG. 7 was developed in response to the observation that the majority of sticking valve issues occur in the first 5,000 miles when the transmission 42 (shown in FIG. 1) is going through a clutch break in period (Oil suspended friction element material is present in higher concentrations during the break in period).

FIG. 8 shows a cleaning frequency based on a time in range parameter. More precisely, FIG. 8 is a graph of cleaning frequency versus time in range wherein the logic valve assembly 8 is cleaned more frequently if the valve 10 remains in a predefined valve position range for a longer period of time. The embodiment shown in FIG. 8 was developed in response to the observation that valves are more likely to stick if they remain in a single position for a long period of time. The time in range parameter is particularly well adapted to clear the valve assembly 8 of the buildup of a plurality of fine particles such as the particles 26 shown in FIG. 2b.

FIG. 9 shows a cleaning frequency based on a shift density parameter. More precisely, FIG. 9 is a graph of cleaning frequency versus shifts per mile wherein the valve assembly 8 is cleaned less frequently as the number of shifts per mile increases. The shift density parameter is particularly well adapted to clear the valve assembly 8 of the buildup of a plurality of fine particle such as the particles 26 shown in FIG. 2b.

FIG. 10 shows a cleaning frequency based on a parameter reflecting the time required to stroke the valve 10. The time required to stroke the valve 10 may be estimated based on valve position data from pressure switches such as the pressure switches 62, 64, 66 (shown in FIG. 1); however, any known methods for measuring valve stroke time may also be implemented. An increase in valve friction due to debris reduces efficiency and may increase valve stroke time. Therefore, if the measured valve stroke time exceeds the optimal valve stroke time by a predetermined amount, an increase in valve cleaning frequency may be triggered. In an alternate embodiment, the time required to de-stroke the valve 10 may be compared with the optimal valve de-stroke time to trigger an increase in valve cleaning frequency.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

1. A method of cleaning a logic valve assembly for a vehicle transmission comprising:
providing a valve assembly comprising a hollow valve body defining a valve bore therein and a valve disposed within said valve bore and normally actuatable in response to a desired transmission operation;
selecting a time period wherein actuation of the logic valve assembly does not effect a gear speed ratio change of the vehicle transmission;
producing a triggering signal in response to a predefined condition; and
actuating said valve during said selected time period in response to said triggering signal to dislodge any debris in the logic valve assembly to clean the valve assembly irrespective of the normal actuation of said valve for a desired transmission operation;
wherein actuating the valve to clean the valve assembly may be performed while the vehicle is being driven and without interfering with vehicle operation such that the valve assembly cleaning is imperceptible to the operator.

2. The method of claim 1, wherein actuating said valve within said valve bore comprises completely stroking the valve from a completely closed position to a completely open position, and de-stroking the valve from a completely open position to a completely closed position multiple times.

3. The method of claim 1, wherein actuating said valve within said valve bore comprises shaking said valve with a high frequency dither having a duration long enough to physically move said valve a slight amount.

4. The method of claim 3, wherein said high frequency dither is based on the natural frequency of said valve.

5. The method of claim 1, wherein actuating said valve within said valve bore comprises partially de-stroking said valve.

6. The method of claim 1, wherein actuating said valve within said valve bore comprises partially stroking said valve.

7. The method of claim 1, wherein said predefined condition is based on a vehicle mileage.

8. The method of claim 1, wherein said predefined condition is based on a time in range.

9. The method of claim 1, wherein said predefined condition is based on a shift density parameter.

10. The method of claim 1, wherein said predefined condition is based on the time required to stroke said valve.

11. A self cleaning logic valve assembly for a vehicle transmission comprising:
a hollow valve body defining a valve bore therein;
a valve disposed within said valve bore of said valve body and normally actuatable in response to a desired transmission operation; and
a programmable controller selectively operable to generate a triggering signal in response to a predefined condition, said programmable controller further operable to actuate said valve for self cleaning in response to said triggering signal and during a predetermined time period without causing an unwanted gear speed ratio change of the vehicle transmission;
wherein said programmable controller may be programmed to actuate the valve for self cleaning while the vehicle is being driven and without interfering with vehicle operation such that the valve assembly cleaning is imperceptible to the operator.

12. The apparatus of claim 11, wherein said programmable controller is adapted to actuate said valve by completely stroking and de-stroking said valve multiple times.

13. The apparatus of claim 11, wherein said programmable controller is adapted to actuate said valve with a high frequency dither having a duration long enough to physically move said valve a slight amount.

14. The apparatus of claim 13, wherein said high frequency dither is based on the natural frequency of said valve.

15. The apparatus of claim 11, wherein said programmable controller is adapted to actuate said valve by partially de-stroking said valve.

16. The apparatus of claim 11, wherein said programmable controller is adapted to actuate said valve by partially stroking said valve.

17. The apparatus of claim 11, wherein said programmable controller is adapted to generate a triggering signal in response to vehicle mileage.

18. The apparatus of claim 11, wherein said programmable controller is adapted to generate a triggering signal in response to a time in range.

19. The apparatus of claim 11, wherein said programmable controller is adapted to generate a triggering signal in response to a shift density parameter.

20. The apparatus of claim 11, wherein said programmable controller is adapted to generate a triggering signal in response to the time required to stroke said valve.

21. A hydraulic control circuit for an automatic transmission comprising:
a plurality of selectively engageable clutches configured to control the engagement of a plurality of gears of the automatic transmission for gear speed ratio selection;
a plurality of logic valves in fluid communication with the plurality of clutches, said plurality of logic valves being configured to control the state of the plurality of clutches and thereby control the gear speed ratio of the automatic transmission; and
a programmable controller selectively operable to generate a triggering signal in response to a predefined condition, said programmable controller further operable to actuate one of said plurality of logic valves for self cleaning in response to said triggering signal and during a predetermined time selected to ensure the state of the plurality of clutches remains constant;
wherein said programmable controller is programmable to actuate one of the plurality of logic valves for self cleaning while the vehicle is being driven and without interfering with vehicle operation such that the logic valve cleaning is imperceptible to the operator.
